(19) United States
(12) Patent Application Publication
(10) Pub. No.: US 2026/0071137 A1
(43) Pub. Date: Mar. 12, 2026

(54) 5,5-DISUBSTITUED TETRAHYDROFURAN-2-ONE AS FRAGRANCE COMPOUNDS

(71) Applicant: Symrise AG, Holzminden (DE)

(72) Inventors: Vijayanand CHANDRASEKARAN, Holzminden (DE); Bernd HÖLSCHER, Halle (DE)

(21) Appl. No.: 18/870,005

(22) PCT Filed: Jun. 1, 2022
(86) PCT No.: PCT/EP2022/064892

§ 371 Date: Nov. 27, 2024

(51) Int. Cl. C11B 9/00

(52) U.S. Cl. CPC C11B 9/0076

(57) ABSTRACT

Suggested is the use of at least one compound of Formula (I) as a fragrance.

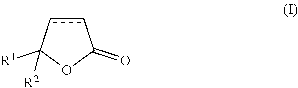

### FIELD OF THE INVENTION

The present invention relates to the use of compounds according to Formula I as fragrance or fragrance compounds. Furthermore, the present invention relates to fragrance compositions comprising said compounds according to Formula I, their use and a method for imparting, modifying and/or enhancing certain fragrance notes. Moreover, the present invention relates to perfumed products comprising the compounds of Formula I.

### BACKGROUND OF THE INVENTION

On the part of the perfume industry, new fragrance creations are permanently needed. However, the creation of a new fragrance or fragrance compositions involves a number of challenges. For example, it is necessary to select a specific composition of a few fragrances from an almost unlimited number of possible structures known from the prior art, in order to satisfy a specific need of the market and provide a product that matches the specific profile required by the customer. Suitable fragrances show a very beneficial performance, but in combination with other fragrances may develop unpleasant and thus detrimental odor aspects, making it difficult or even impossible to use them for the specific purpose.

Furthermore, the current trend in fragrance industry is renewable products. However, it is a challenging task to identify renewable compounds which can be part of renewable products and which also have positive odor properties. Moreover, the fragrances or fragrance composition should not only have a particular odor profile, but also possess so-called secondary beneficial properties. Indeed, many fragrance compositions known from the market have significant drawbacks in use, such as poor solubility and stability to storage, but also failures in subjective issues such as richness, charisma, and the like. In addition, many known fragrance compositions require high dosages to achieve the desired odor result. Another requirement for fragrances today is high biodegradability as well as dermatological and toxicological safety. Consequently, there is a particularly high demand for providing fragrances that have a large effect on other fragrances even at small dosages and change rather unpleasant odor impressions into positive ones and/or enhance pleasant odor impressions.

Thus, the underlying problem of the present invention was to provide a new fragrance with the ability to enhance positive and beneficial fragrance aspects of other fragrances and/or (at the same time) to reduce, inhibit and/or mask undesirable unpleasant fragrance aspects. Furthermore, the new fragrance should be renewable as well as stable. Finally, the fragrance compositions themselves should have excellent biodegradability and be harmless to humans and the environment.

### DESCRIPTION OF THE INVENTION

This is solved by the use of least one compound of Formula I

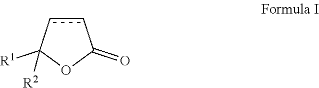

as a fragrance, wherein
R¹ represents H, methyl, ethyl, propyl, butyl, hexyl, heptyl, octyl, nonyl, vinyl, allyl, 2-methylprop-1-enyl or 2-methylallyl;
R² represents H, methyl or ethyl and
the dotted line represents a carbon-carbon single bond or a carbon-carbon double bond.

The compounds according to Formula I to be used according to the invention may be present in any stereoisomeric form or may be present as any mixture of stereoisomers.

What has been said herein for compounds of Formula I, in particular the advantages described herein, also apply to a mixture of stereoisomers of compounds of Formula I to be used or to be employed according to the invention or to a mixture of different compounds of Formula I.

The compounds of Formula I possess olfactory properties which are quite unique and which clearly differ from and also surpass those of known odoriferous substances. The suitability of the compounds of Formula I as fragrances was previously unknown. It is therefore particularly surprising that in the already well-studied field a fragrance with valuable, interesting and complex olfactory properties could be found.

As mentioned above, the suitability as a fragrance for the compounds of Formula I is not known. Likewise, no precise odor description is available, however, according to the inventors, the compounds of Formula I smell in particular fruity, apricot, cumarin, creamy, coconut, green, mint, sweet, almond, fresh, soft, natural, tonka, tobacco and/or hay.

Consequently, the inventors have made the surprising discovery that the compounds of Formula I are suitable as a fragrance and, in small dosages, produce special effects in combination with other fragrances which are not necessarily related to their own odor but, in combination with other, especially floral fragrances, convey a completely different note.

For the sake of clarity, by the expression “the dotted lines represent a carbon-carbon single bond or a carbon-carbon double bond”, or the similar, it is meant the normal meaning understood by a person skilled in the art, i.e. that the whole bonding (solid and dotted line) between the carbon atoms connected by said dotted line is a single or a double bond.

In a preferred embodiment according to the invention R1 represents methyl, ethyl, butyl, vinyl, allyl, 2-methylprop-1-enyl, 2-methylallyl, octyl or nonyl; and R2 represent methyl or ethyl.

In a further preferred embodiment according to the invention, the compound of Formula I is selected from the group consisting of 5,5-dimethyltetrahydrofuran-2-one, 5-ethyl-5-methyl-tetrahydrofuran-2-one, 5,5-diethyltetrahydrofuran-2-one, 5-5 methyl-5-vinyl-tetrahydrofuran-2-one, 5-allyl-5-methyl-tetrahydrofuran-2-one, 5-methyl-5-(2-methylprop-1-enyl)tetrahydrofuran-2-one, 5-methyl-5-(2-methylallyl)tetrahydrofuran-2-one, 5-methyl-5-octyl-tetrahydrofuran-2-one, 5-methyl-5-nonyl-tetrahydrofuran-2-one, 5-butyl-5-ethyl-tetrahydrofuran-2-one, 5-butyl-5-ethyl-furan-2-one.

The preferred compounds according to the invention have the following structural formula and odor characteristics:

TABLE 1
Preferred compounds of Formula I

| | | Odor |
|---|---|---|
| Name | Structure | description |
| 5,5- dimethyltetrahydrofuran- 2-one | 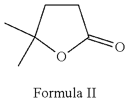 | Fruity, apricot, cumarin, creamy |
| 5-ethyl-5-methyl- tetrahydrofuran-2-one | 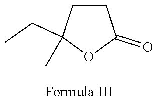 | Lactonic, coconut, green |
| 5,5- diethyltetrahydrofuran-2- one | 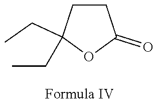 | Lactonic, green, fatty, weak coconut |
| 5-methyl-5-vinyl- tetrahydrofuran-2-one | 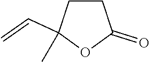 | Mint, sweet, almond |
| | Formula V | |
| 5-allyl-5-methyl- tetrahydrofuran-2-one | 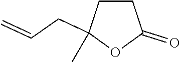 | Fresh, coconut, soft, natural |
| | Formula VI | |
| 5-methyl-5-(2- methylprop-1- enyl)tetrahydrofuran-2- one | 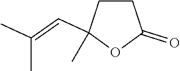 | Strong Tonka/cuma- rin, coconut, tobacco, hay |
| | Formula VII | |
| 5-methyl-5-(2- methylallyl)tetrahydrofuran- 2-one | 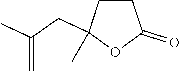 | Strong Tonka/cuma- rin, coconut, tobacco, hay |
| | Formula VIII | |
| 5-methyl-5-octyl- tetrahydrofuran-2-one | 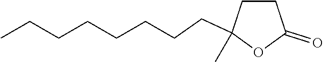 | weak lactonic fatty |
| | Formula IX | |
| 5-methyl-5-nonyl- tetrahydrofuran-2-one | 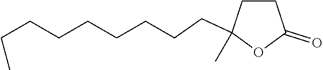 [SMILES: CCCCCCCCCC1(C)CCC(=O)O1] | too weak lactonic |
| | Formula X | |
| 5-butyl-5-ethyl- tetrahydrofuran-2-one | 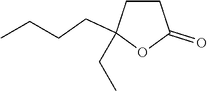 | Lactone, fruity, coconut |
| | Formula XI | |
| 5-butyl-5-ethyl-furan-2- one | 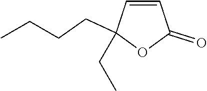 | pungent, technical, dusty |
| | Formula XII | |

In a most preferred embodiment according to the invention the compound of Formula I is 5,5-dimethyltetrahydrofuran-2-one. Preferably, 5,5-dimethyltetrahydrofuran-2-one has the following fragrance notes: fruity, apricot, cumarin, creamy.

In a preferred embodiment according to the invention, at least one compound of Formula I is used in a fragrance composition to obtain at least one of the following fragrance notes: fruity, apricot, cumarin, creamy, coconut, green, mint, sweet, almond, fresh, soft, natural, tonka, tobacco and/or hay. Further preferred is the use of at least one compound of Formula I for imparting, modifying and/or enhancing a fragrance composition to make it rounder, more natural, more volume, more honey, stronger and/or fruitier and/or for imparting, modifying and/or enhancing a fragrance composition to make it less greasy and/or less mushroom. This is, however particularly surprising in light of the above odor description, since some compounds of Formula I do not have any fruity, juicy or floral note and/or even a less pleasant odor note, for example 5-methyl-5-octyl-tetrahydrofuran-2-one, 5-methyl-5-nonyl-tetrahydrofuran-2-one or 5-butyl-5-ethyl-furan-2-one.

The fact that compounds of Formula I to be used according to the invention may impart a very complex and varied overall sensory impression, which can otherwise usually only be achieved by mixtures of several components (such as essential oils or spice mixtures), is particularly surprising.

Beyond the primary, namely olfactory, properties, compounds of Formula I additionally possess positive secondary properties, in particular a high substantivity compared to fragrances with similar olfactory properties, as well as a high stability in certain media and preparations, a high extensibility, and is also biodegradable.

In connection with the preferred use for imparting, modifying and/or enhancing a fragrance note, it is also recognized that compounds of Formula I can excellently function as a so-called booster (amplifier; enhancer). Therefore, in one aspect, the present invention relates to the use of at least one compound of Formula I to enhance one or more odor notes. as explained above, the odor notes which should be enhanced are preferably selected from round, natural, volume, honey, strong and/or fruity. Preferably, the at least one compound of Formula I is 5,5-dimethyltetrahydrofuran-2-one.

Moreover, compounds of Formula I to be used according to the invention can enhance the intensity of a fragrance mixture (fragrance composition) and round off the overall odor of the mixture. The compounds described herein can therefore be used to impart more fullness, freshness, (radiance) power, radiance, roundness, harmony, naturalness and/or less greasiness to a fragrance composition, in particular the compound can be used to impart more naturalness, more roundness and/or more freshness to a fragrance composition.

Furthermore, the compounds of Formula I are suitable as an agent for increasing the substantivity and/or retention of a fragrance composition.

The compounds of Formula I can be used in a variety of products; they can be used as a single fragrance, but they can be combined particularly advantageously with other fragrances in different, different proportions to form fragrance mixtures, and novel and original perfume compositions can also be created. Accordingly, one aspect of the invention also relates to fragrance mixture and possibly further constituents (solvents or the like), which contains at least one compound of Formula I, preferably 5,5-dimethyltetrahydrofuran-2-one.

The fragrance composition according to the invention comprises or consists of at least one compound of Formula I

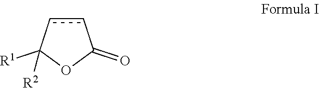

wherein
R¹ represents H, methyl, ethyl, propyl, butyl, hexyl, heptyl, octyl, nonyl, vinyl, allyl, 2-methylprop-1-enyl or 2-methylallyl;
R² represents H, methyl or ethyl and
the dotted line represents a carbon-carbon single bond or a carbon-carbon double bond; and at least one further fragrance.

In a preferred embodiment according to the invention R1 represents methyl, ethyl, butyl, vinyl, allyl, 2-methylprop-1-enyl, 2-methylallyl, octyl or nonyl; and R2 represent methyl or ethyl.

In a further preferred embodiment according to the invention, the compound of Formula I is selected from the group consisting of 5,5-dimethyltetrahydrofuran-2-one, 5-ethyl-5-methyl-tetrahydrofuran-2-one, 5,5-diethyltetrahydrofuran-2-one, 5-methyl-5-vinyl-tetrahydrofuran-2-one, 5-allyl-5-methyl-tetrahydrofuran-2-one, 5-methyl-5-(2-methylprop-1-enyl)tetrahydrofuran-2-one, 5-methyl-5-(2-methylallyl)tetrahydrofuran-2-one, 5-methyl-5-octyl-tetrahydrofuran-2-one, 5-methyl-5-nonyl-tetrahydrofuran-2-one, 5-butyl-5-ethyl-tetrahydrofuran-2-one, 5-butyl-5-ethyl-furan-2-one. Most preferably, the compound of Formula I is 5,5-dimethyltetrahydrofuran-2-one.

Preferably, the fragrance composition according to the invention comprises or consists of at least one compound of Formula I and two or more further fragrances. More preferably, the fragrance composition according to the invention comprises or consists of at least one compound of Formula I and three or more further fragrances. Most preferably, the fragrance composition according to the invention comprises or consists of at least one compound of Formula I and four or more further fragrances.

Preferably, the fragrance composition according to the invention comprises or consists of 5,5-dimethyltetrahydrofuran-2-one and two or more further fragrances. More preferably, the fragrance composition according to the invention comprises or consists of 5,5-dimethyltetrahydrofuran-2-one and three or more further fragrances. Most preferably, the fragrance composition according to the invention comprises or consists of 5,5-dimethyltetrahydrofuran-2-one and four or more further fragrances.

The compounds of Formula I according to the invention are usually used in sensory effective amounts, i.e. in a total amount in which they exert a sensory effect.

Preferably, the weight ratio of the at least one compound of Formula I to the total amount of other fragrances is in the range of 1:10 to 1:100. More preferably, the weight ratio of the at least one compound of Formula I to the total amount of other fragrances is in the range of 1:600 to 1:400.

In this context, it is preferred if the total amount of the at least one compound of Formula I is in the range from 0.0001 to 99.9% by weight, preferably from 0.001 to 99.5% by weight, particularly preferably from 0.01 to 99% by weight, from 0.01 to 90% by weight, from 0.01 to 50% by weight, from 0.01 to 20% by weight, from 0.01 to 10% by weight and particularly preferably from 0.01 to 5% by weight, in particular from 0.05 to 2.0% by weight, in each case based on the total weight of the composition.

In a preferred embodiment according to the invention, the compounds of Formula I are contained in the fragrance composition in a sensory effective amount sufficient to modify an existing fragrance to make it rounder, more natural, more volume, more honey, stronger and/or fruitier and/or for imparting, modifying and/or enhancing a fragrance composition to make it less greasy and/or less mushroom.

Examples of fragrances which may advantageously be combined with the compounds of Formula I in the context of the present invention can be found, for example, in S. Arctander, Perfume and Flavor Materials, Vol. I and II, Montclair, N. J. 1969, self-published, or K. Bauer ei a/., Common Fragrance and Flavor Materials, 4th Edition, Wiley-VCH, Weinheim 2001.

Specifically mentioned are: Extracts from natural raw materials such as essential oils, concretes, absolutes, resins, resinoids, balsams, tinctures such as. Ambergris tincture; Amyris oil; Angelica seed oil; Angelica root oil; Anise oil; Valerian oil; Basil oil; tree moss absolute; bay oil; mugwort oil; benzoeresin; bergamot oil; Beeswax absolue; Birch tar oil; Bitter almond oil; Savory oil; Bucco leaf oil; Cabreuva oil; Cade oil; Calmus oil; Camphor oil; Cananga oil; Cardamom oil; Cascarilla oil; Cassia oil; Cassie-absolue; Castoreum-absolue; Cedar leaf oil; Cedarwood oil; Cistus oil; Citronella oil; Citron oil; Copaiva balsam; Copaiva balsam oil; Coriander oil; Costus root oil; Cumin oil; Cypress oil; Davana oil; Dill herb oil; Dill seed oil; Eau de brouts-Absolue; Oak moss absolute; Elemi oil; Tarragon oil; Eucalyptus citriodora oil; Eucalyptus oil; Fennel oil; Spruce needle oil; Galbanum oil; Galbanum resin; Geranium oil; Grapefruit oil; Guaiac wood oil; Gurjun balsam; Gurjun balsam oil; Helichrysum absolute; Helichrysum oil; Ginger oil; Iris root absolute; Iris root oil; Jasmine absolute; Calamus oil; Chamomile oil blue; Chamomile oil roman; Carrot seed oil; Cascarilla oil; Pine needle oil; Spearmint oil; Caraway oil; labdanum oil; labdanum absolute; labdanum resin; lavandin absolute; Lavandin oil; Lavender absolute; Lavender oil; Lemongrass oil; Lovage oil; Lime oil distilled; Lime oil pressed; Linaloe oil; Litsea cubeba oil; Bay leaf oil; Mace oil; Marjoram oil; Mandarin oil; Massoir bark oil; Mimosa absolute; Musk grain oil; Musk tincture; Muscat sage oil; Nutmeg oil; Myrrh absolute; Myrrh oil; Myrtle oil; Clove leaf oil; Clove flower oil; Neroli oil; Olibanum absolute; Olibanum oil; Opopanax oil; orange blossom absolute; orange oil; Origanum oil; palmarosa oil; patchouli oil; Perilla oil; Perubalsam oil; Parsley leaf oil; Parsley seed oil; Petitgrain oil; Peppermint oil; Pepper oil; Allspice oil; Pine oil; Poley oil; Rose absolute; Rosewood oil; Rose oil; Rosemary oil; Sage oil Dalmatian; Sage oil Spanish; Sandalwood oil; Celery seed oil; Spicy lavender oil; Star anise oil; Styrax oil; Tagetes oil; Fir needle oil; Tea tree oil; Turpentine oil; Thyme oil; Tolu balsam; Tonka absolue; tuberose-absolue; vanilla extract; violet leaf-absolue; Verbena oil; vetiver oil; juniper berry oil; wine yeast oil; wormwood oil; wintergreen oil; ylang oil; hyssop oil; civet-absolue; cinnamon leaf oil; cinnamon bark oil and fractions thereof, or Ingredients isolated therefrom;
Individual odorants from the group of hydrocarbons, such as 3-carene; α-pinene; β-pinene; a-terpinene; γ-terpinene; p-cymene; bisabolene; camphene; caryophyllene; cedrene; farnesene; limonene; longifolene; myrcene; ocimene; valencene; (E,Z)-1,3,5-undecatriene; styrene; diphenylmethane;
of the aliphatic alcohols such as Hexanol; octanol; 3-octanol; 2,6-dimethylheptanol; 2-methyl-2-heptanol; 2-methyl-2-octanol; (E)-2-hexenol; 1-octen-3-ol; mixture of 3,4,5,6,6-pentamethyl-3/4-hepten-2-ol and 3,5,6,6-tetramethyl-4-methyleneheptan-2-ol; (E,Z)-2,6-nonadienol; 3,7-dimethyl-7-methoxyoctan-2-ol; 9-decenol; 10-undecenol; 4-methyl-3-decen-5-ol;
of aliphatic aldehydes and their acetals, such as Hexanal; heptanal; octanal; nonanal; decanal; undecanal; dodecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-9-undecenal; 2,6,10-trimethyl-5,9-undecadienal; heptanaldiethyl acetal; 1,1-dimethoxy-2,2,5-trimethyl-4-hexene; citronellyloxyacetaldehyde; 1-(1-methoxy-propoxy)-(E/Z)-3-hexene;
of aliphatic ketones and their oximes such as 2-heptanone; 2-octanone; 3-octanone; 2-nonanone; 5-methyl-3-heptanone; 5-methyl-3-heptanone oxime; 2,4,4,7-tetramethyl-6-octen-3-on; 6-methyl-5-hepten-2-one;
of aliphatic sulfur-containing compounds such as 3-methylthiohexanol; 3-methylthiohexyl acetate; 3-mercaptohexanol; 3-mercaptohexyl acetate; 3-mercaptohexyl butyrate; 3-acetylthiohexyl acetate; 1-menthen-8-thiol;
of aliphatic nitriles such as 2-nonenoic acid nitrile; 2-undecenoic acid nitrile; 2-tridecenoic acid nitrile; 3,12-tridecadienoic acid nitrile; 3,7-dimethyl-2,6-octadienoic acid nitrile; 3,7-dimethyl-6-octenoic acid nitrile;
esters of aliphatic carboxylic acids, e.g. (E)- and (Z)-3-hexenyl formate; ethyl acetoacetate; isoamyl acetate; 3,5,5-trimethylhexyl acetate; 3-methyl-2-butenyl acetate; (E)-2-hexenyl acetate; (E)- and (Z)-3-hexenyl acetate; Octyl acetate; 3-octyl acetate; 1-octene-3-yl acetate; ethyl butyrate; butyl butyrate; isoamyl butyrate; hexyl butyrate; (E)- and (Z)-3-hexenyl isobutyrate; Hexyl crotonate; ethyl isovalerate; ethyl 2-methylpentanoate; ethyl hexanoate; allyl hexanoate; ethyl heptanoate; allyl heptanoate;
ethyl octanoate; Ethyl (E,Z)-2,4-decadienoate; methyl 2-octinate; methyl 2-noninate; allyl 2-isoamyloxyacetate; M ethy 1-3,7-dimethyl-2,6-octadiene-oate; 4-methyl-2-pentyl crotonate;
of acyclic terpene alcohols such as. Geraniol; nerol; lavadulol; nerolidol; farnesol; tetrahydrolinalool; tetrahydrogeraniol; 2,2-Dimethyl-3-(3-methylphenyl) propan-1-ol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-Dimethyloct-6-en-1-ol; (2E)-3,7-Dimethylocta-2,6-dien-1-ol; 3,7-dimethyl-1,5,7-octatrien-3-ol 2,6-dimethyl-2,5J-octatrien-1-ol; and their formates, acetates, propionates, isobutyrates, butyrates, isovalerianates, pentanoates, hexanoates, crotonates, tiglinates and 3-methyl-2-butenoates;
of the acyclic terpene aldehydes and ketones such as citronellal; 7-methoxy-3,7-dimethyloctanal; 2,6,10-trimethyl-9-undecenal; geranylacetone; and the dimethyl and diethylacetals of geranial, neral,
of cyclic terpene alcohols such as. menthol; isopulegol; alpha-terpineol; terpinenol-4; menthan-8-ol; menthan-1-ol; menthan-7-ol; borneol; isoborneol; linalool oxide; nopol; cedrol; ambrinol; vetiverol; guaiaol; and their formates, acetates, propionates, isobutyrates, butyrates, isovalerianates, pentanoates, hexanoates, crotonates, tiglinates and 3-methyl-2-butenoates;
of cyclic terpene aldehydes and ketones such as Menthone; isomenthone; 8-mercaptomenthan-3-on; carvone; camphor; fenchone; alpha-lonone; beta-lonone;

alpha-n-methylionone; beta-n-methylionone; alpha-Isomethylionone; beta-Isomethyl-ionone; alpha-irone; beta-damascenone; 1-(2,4,4-trimethyl-2-cyclohexen-1-yl)-2-buten-1-one; 1,3,4,6,7,8a-Hexahydro-1,1,5,5-tetramethyl-2H-2,4a-methano-naphthalen-8 (5H)-on; 2-Methyl-4-(2,6,6-trimethyl-1-cyclohexen-1-yl)-2-butenal; Nootkatone; dihydronootkatone; 4,6,8-megastigmatriene-3-on; alpha-sinensal; beta-sinensal; acetylated cedarwood oil (methylcedrylketone);
of cyclic alcohols such as 4-tert-butylcyclohexanol; 3,3,5-trimethylcyclohexanol; 3-Isocamphylcyclohexanol; 2,6,9-trimethyl-Z2,Z5,E9-cyclododecatrien-1-ol; 2-Isobutyl-4-m ethyltetrahydro-2H-pyran-4-ol; 4-cyclohexylbutan-2-ol;
of cycloaliphatic alcohols such as. alpha,3,3-trimethylcyclohexylmethanol; 1-(4-Isopropylcyclohexyl) ethanol; 2-methyl-4-(2,2,3-trimethyl-3-cyclopent-1-yl) butanol; 2-methyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-Methyl-5-(2,2,3-trimethyl-3-cyclopent-1-yl)-4-penten-2-ol; 3,3-Dimethyl-5-(2,2,3-trimethyl-3-cyclopent-1-yl)-4-penten-2-ol; 1-(2,2,6-Trimethylcyclohexyl) pentan-3-ol; 1-(2,2,6-Trimethylcyclohexyl) hexan-3-ol;
cyclic and cycloaliphatic ethers, e.g. Cineol; cedryl methyl ether; cyclododecyl methyl ether; 1,1-dimethoxycyclododecane; (ethoxymethoxy)cyclo-dodecane; alpha-cedrene epoxide; 3a,6,6,9a-tetramethyldodecahydro-naphtho[2,1-b]furan; 3a-ethyl-6,6,9a-trimethyldodecahydronaphtho[2,1 b]furan; 1,5,9-tri-methyl-13-oxabicyclo[10.1. 0]trideca-4,8-diene; rose oxide; 2-(2,4-dimethyl-3-cyclohexen-1-yl)-5-methyl-5-(1-methyl propyl)-1,3-d ioxane;
of cyclic and macrocyclic ketones such as 4-tert.-butylcyclohexanone; 2,2,5-trimethyl-5-pentylcyclopentanone; 2-heptylcyclopentanone; 2-pentyl-cyclopentanone; 2-hyd roxy-3-methyl-2-cyclopenten-1-one; 3-methyl-cis-2-penten-1-yl-2-cyclopenten-1-one; 3-methyl-2-pentyl-2-cyclopenten-1-one; 3-methyl-4-cyclopentadecenone; 3-methyl-5-cyclopentadecenone; 3-methylcyclopenta-decanone; 4-(1-ethoxyvinyl)-3,3,5,5-tetramethylcyclohexanone; 4-tert.-pentylcyclo-hexanone; 5-cyclohexadecen-1-one; 6,7-dihydro-1,1,2,3,3-pentamethyl-4 (5H)-indanone; 8-cyclohexadecen-1-one; 9-cycloheptadecen-1-on; cyclopentadecanone; cyclohexadecanone;
of cycloaliphatic aldehydes such as 2-methyl-4-(2,2,6-trimethyl-cyclohexen-1-yl)-2-butenal; 4-(4-hydroxy-4-methylpentyl)-3-cyclohexenecarbaldehyde; 4-(4-methyl-3-penten-1-yl)-3-cyclohexenecarbald ehyde;
of cycloaliphatic ketones, e.g. 1-(3,3-Dimethylcyclohexyl)-4-penten-1-on; 2,2-Dimethyl-1-(2,4-dimethyl-3-cyclohexen-1-yl)-1-propanon; 1-(5,5-Dimethyl-1-cyclohexen-1-yl)-4-penten-1-on; 2,3,8,8-tetramethyl-1,2,3,4,5,6,7,8-octahydro-2-naphthalenyl methyl ketone; methyl 2,6,10-trimethyl-2,5,9-cyclododecatrienyl ketone; tert.-butyl-(2,4-dimethyl-3-cyclohexen-1-yl) ketone;
of ester of cyclic alcohols such as 2-tert-butylcyclohexyl acetate; 4-tert-butylcyclohexyl acetate; 2-tert-pentylcyclohexyl acetate; 4-tert-pentylcyclohexyl acetate; 3,3,5-tri methylcyclohexyl acetate; decahyd ro-2-naphthyl acetate; 2-cyclo-pentylcyclopentyl crotonate; 3-pentyl tetrahydro-2H-pyran-4-yl acetate; decahydro-2,5,5,8a-tetramethyl-2-naphthyl acetate; 4,7-methano-3a,4,5,6,7,7a-hexa-hydro-5, resp. 6-indenyl acetate; 4,7-methano-3a,4,5,6,7,7a-hexahydro-5, or 6-indenyl propionate; 4,7-methano-3a,4,5,6,7,7a-hexahydro-5, or 6-indenyl isobutyrate; 4,7-methanooctahydro-5, or 6-indenyl acetate;
of esters of cycloaliphatic alcohols such as 1-cyclohexylethyl crotonate;
of esters of cycloaliphatic carboxylic acids, e.g. Allyl 3-cyclohexyl propionate; allyl cyclohexyloxy acetate; ice and trans-methyl dihydrojasmonate; ice and trans-methyl jasmonate; methyl 2-hexyl-3-oxocyclopentane carboxylate; ethyl 2-ethyl-6,6-dimethyl-2-cyclohexene carboxylate; ethyl 2,3,6,6-tetramethyl-2-cyclohexene carboxylate; ethyl 2-methyl-1,3-dioxolane-2-acetate;
of araliphatic alcohols such as Benzyl alcohol; 2-phenylethanol; 1-phenylethyl alcohol; 3-phenylpropanol; 2-phenylpropanol; 2-phenoxyethanol; 2,2-dimethyl-3-phenylpropanol; 2,2-dimethyl-3-(3-methylphenyl) propanol; 1,1-dimethyl-2-phenylethyl alcohol; 1,1-dimethyl-3-phenylpropanol; 1-ethyl-1-methyl-3-phenyl-propanol; 2-methyl-5-phenylpentanol; 3-methyl-5-phenylpentanol; 3-phenyl-2-propen-1-ol; 4-methoxybenzyl alcohol; 1-(4-Isopropylphenyl) ethanol;
of esters of araliphatic alcohols and aliphatic carboxylic acids, e.g. Benzyl acetate; benzyl propionate; benzyl isobutyrate; benzyl isovalerate; 2-phenylethyl acetate; 2-phenylethyl propionate; 2-phenylethyl isobutyrate; 2-phenyl ethyl isovalerate; 1-phenylethyl acetate; alpha-trichloromethyl benzyl alpha, alpha-dimethylphenyl ethyl acetate; alpha,alpha-dimethylphenyl ethyl butyrate; cinnamyl acetate; 2-phenoxyethyl isobutyrate; 4-methoxybenzyl acetate;
of araliphatic ethers such as. 2-phenylethyl methyl ether; 2-phenylethyl isoamyl ether; 2-phenylethyl 1-ethoxyethyl ether; phenylacetaldehyde dimethyl acetal; phenylacetaldehyde diethyl acetal; hydratropaaldehyde dimethyl acetal; phenylacetaldehyde glycerol acetal; 2,4,6-trimethyl-4-phenyl-1,3-dioxane; 4,4a,5,9b-tetra-hydroindeno[1,2-d]-m-dioxin; 4,4a,5,9b-tetrahydro-2,4-dimethylindeno[1,2-d]-m-dioxin; of aromatic and araliphatic aldehydes such as. e.g., benzaldehyde;
phenylacetaldehyde; 3-phenylpropanal; hydratropaaldehyde; 4-methylbenzaldehyde; 4-methylphenylacetaldehyde; 3-(4-ethylphenyl)-2,2-dimethylpropanal; 2-methyl-3-(4-isopropylphenyl) propanal; 2-methyl-3-(4-isobutylphenyl) propanal; 3-(4-tert. butyl-phenyl) propanal; cinnamaldehyde; alpha-butylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylenedioxybenzaldehyde; 3,4-dimethoxybenzaldehyde; 2-methyl-3-(4-methoxyphenyl) propanal; 2-methyl-3-(4-methylenedioxyphenyl) propanal;
of aromatic and araliphatic ketones such as acetophenone; 4-methylacetophenone; 4-methoxyacetophenone; 4-tert.-butyl-2,6-dimethylaceto-phenone; 4-phenyl-2-butanone; 4-(4-hydroxyphenyl)-2-butanone; 1-(2-naphtha-lenyl) ethanone; 2-benzofuranylethanone; (3-methyl-2-benzofuranyl) ethanone; benzophenone; 1,1,2,3,6-hexamethyl-5-indanyl methyl ketone; 6-tert. butyl-1,1-di-methyl-4-indanyl methyl ketone; 1-[2,3-dihydro-1,1,2,6-tetramethyl-3-(1-methylethyl)-1H-5-indenyl]ethanone; 5′,6′,7′,8′-tetrahydro-3′,5′,5′,6′,8′,8′-hexamethyl-2-aceto-naphthone;
of aromatic and araliphatic carboxylic acids and their esters, e.g. Benzoic acid; phenylacetic acid; methyl benzoate; ethyl benzoate; hexyl benzoate; benzyl benzoate; methyl phenyl acetate; ethyl phenyl acetate; geranyl phenyl acetate; phenyl ethyl phenyl acetate; methyl cinnamate; ethyl cinnamate; benzyl cinnamate; phenyl ethyl cinnamate; cinnamyl cinnamate; allyl phenoxy acetate; methyl salicylate; hexyl salicylate; cyclohexyl salicylate; cis-3-hexenyl salicylate; benzyl salicylate; phenyl ethyl salicylate; methyl 2,4-dihydroxy-3,6-dimethylbenzoate; ethyl 3-phenyl glycidate; ethyl 3-methyl-3-phenyl glycidate;
of heterocyclic compounds such as 2,5-dimethyl-4-hydroxy-2H-furan-3-one; 2-ethyl-4-hydroxy-5-methyl-2H-f u ran-3-on; 3-hydroxy-2-methyl-4H-pyran-4-one; 2-ethyl-3-hydroxy-4H-pyran-4-one;
of lactones such as. 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 4-methyl-1,4-decanolide; 1,15-pentadecanolide; 1,16-hexadeca-nolide; 9-hexadecene-1,16-olide; 10-oxa-1,16-hexadecanolide; 11-oxa-1,16-hexa-decanolide; 12-oxa-1,16-hexadecanolide; ethylene-1,12-dodecanedioate; ethylene-1,13-tridecanedioate; 2,3-dihydrocoumarin; octahydrocoumarin.

In a further preferred embodiment of the invention, the compounds of Formula I are preferably combined with one or more, particularly preferably with two, three, four, five or more other fragrances that have a floral odor note.

Correspondingly, the present invention also relates to a fragrance composition which comprises one, two, three, four, five or more other fragrances which convey a floral odor note.

The compounds to be used according to the invention advantageously (at least partially) achieves an odor enhancement of the flowery fragrance notes.

In a preferred embodiment according to the invention, the at least one further fragrance is selected from the group consisting of 4-cyclohexylbutan-2-ol (Cyclohexylmagnol), 2-methyl-5-phenylpentan-1-ol (Rosaphen), 2-phenylethanol (Phenylethylalkohol), Methyl-3-oxo-2-pentyl-1-cyclopentylacetat (Hedion), 1-(4-isopropylcyclohexyl)-ethanol) (Mugetanol), 3,7-Dimethyloct-6-en-1-ol (Citronellol), (2E)-3,7-Dimethylocta-2,6-dien-1-ol (Geraniol), 2,6-Dimethyl-7-octen-2-ol (Dihydromyrcenol) and/or 2,2-Dimethyl-3-(3-methylphenyl) propan-1-ol (Majantol) and/or Benzyl 2-hydroxybenzoate (Benzyl salicylate).

Preferably, 5,5-dimethyltetrahydrofuran-2-one is combined with one or more, particularly preferably with two, three, four, five or more of those preferred other fragrances.

Perfume oil compositions (=fragrance mixtures) containing at least one compound of Formula I are advantageously used for perfuming in liquid form, undiluted or diluted with a solvent. Suitable solvents for this are e.g. Ethanol, isopropanol, diethylene glycol monoethyl ether, glycerin, propylene glycol, 1,2-butylene glycol, dipropylene glycol, diethyl phthalate, triethyl citrate, isopropyimyristate etc.

Furthermore, fragrance compositions according to the invention can be adsorbed on a carrier, which ensures both a fine distribution of the fragrances in the product and a controlled release during use. Such carriers can be porous inorganic materials such as light sulfate, silica gels, zeolites, plasters, clays, clay granules, aerated concrete, etc. or organic materials such as wood, cellulose-based substances, sugar, dextrins (e.g. maltodextrin) or plastics such as PVC, polyvinyl acetates or polyurethanes. The resulting combination of compositions according to the invention and carrier substance is also to be understood as a fragrance composition according to the invention.

Fragrance compositions according to the invention can also be microencapsulated, spray-dried, as inclusion complexes or as extrusion products and added in this form to a product to be perfumed, for example.

If necessary, the properties of the compositions modified in this way can be further optimized by so-called “coating” with suitable materials with a view to a more targeted release of fragrances, for which purpose waxy plastics such as polyvinyl alcohol are preferably used. The resulting products in turn represent articles according to the invention.

A further aspect of the present invention relates to the use of the fragrance composition to modify an existing fragrance to make it rounder, more natural, more volume, more honey, stronger and/or fruitier and/or for imparting, modifying and/or enhancing a fragrance composition to make it less greasy and/or less mushroom. Preferred embodiments listed above also apply to the use of the fragrance composition.

Fragrance compositions according to the invention can advantageously be used in concentrated form, in solutions or in the modified form described above for the production of perfumed articles according to the invention, such as. B. perfume extracts, eau de perfumes, eau de toilettes, aftershave, eau de colognes, pre-shave products, splash colognes and perfumed refreshing towels and the perfuming of acidic, alkaline and neutral cleaning agents such as floor cleaners, window glass cleaners, dishwashing detergents, Bathroom and sanitary cleaners, scouring milk, solid and liquid toilet cleaners, powder and foam carpet cleaners, textile fresheners, ironing aids, liquid detergents, powder detergents, laundry pretreatment agents such as bleaches, soaking agents and stain removers, fabric softeners, laundry soaps, washing tablets, and disinfectants Air fresheners in liquid, gel-like or applied form on a solid carrier, aerosol sprays, waxes and polishes such as furniture polishes, floor waxes, shoe creams and personal care products such as solid and liquid soaps, shower gels, shampoos, shaving soaps, shaving foams s, bath oils, cosmetic emulsions of the oil-in-water, of the water-in-oil and of the water-in-oil-in-water type such as, for example, skin creams and lotions, face creams and lotions, sun protection creams and lotions, after-sun creams and lotions, hand creams and lotions, foot creams and lotions, depilatory creams and lotions, after-shave creams and lotions, tanning creams and lotions, hair care products such as hair sprays, hair gels, setting hair lotions, Hair conditioners, permanent and semi-permanent hair dyes, hair shaping agents such as cold waves and hair straighteners, hair lotions, hair creams and lotions, deodorants and antiperspirants such as underarm sprays, roll-ons, deodorant sticks, deodorant creams, products in decorative cosmetics such as eye shadow, nail varnish, Lipsticks, mascara and candles, lamp oils, incense sticks, insecticides, repellants and fuels.

Of course, fragrance compositions according to the invention can also be included in cosmetic compositions or household compositions.

Another aspect of the invention relates to a method for modifying an existing fragrance to make it more fruity, juicier, softer, clearer, fresher, sweeter and/or more floral,
comprising or consisting of the following steps:
(a) providing at least one compound of Formula I

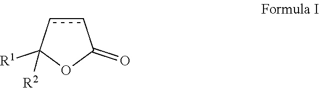

wherein
R¹ represents H, methyl, ethyl, propyl, butyl, hexyl, heptyl, octyl, nonyl, vinyl, allyl, 2-methylprop-1-enyl or 2-methylallyl;
R² represents H, methyl or ethyl and
the dotted line represents a carbon-carbon single bond or a carbon-carbon double bond;
(b) providing at least one further fragrance; and
(c) adding the at least one compound of Formula (I) to the at least one further fragrance in a sensory effective amount sufficient to modify an existing fragrance to make it rounder, more natural, more volume, more honey, stronger and/or fruitier and/or for imparting, modifying and/or enhancing a fragrance composition to make it less greasy and/or less mushroom.

Preferably, the weight ratio of the at least one compound of Formula I to the total amount of other fragrances is in the range of 1:10 to 1:100. More preferably, the weight ratio of the at least one compound of Formula I to the total amount of other fragrances is in the range of 1:600 to 1:400.

In this context, it is preferred if the total amount of the at least one compound of Formula I is in the range from 0.0001 to 99.9% by weight, preferably from 0.001 to 99.5% by weight, particularly preferably from 0.01 to 99% by weight, from 0.01 to 90% by weight, from 0.01 to 50% by weight, from 0.01 to 20% by weight, from 0.01 to 10% by weight and particularly preferably from 0.01 to 5% by weight, in particular from 0.05 to 2.0% by weight, in each case based on the total weight of the composition.

In a preferred embodiment according to the invention, the at least one further fragrance is selected from the group consisting of 4-cyclohexylbutan-2-ol (Cyclohexylmagnol), 2-methyl-5-phenylpentan-1-ol (Rosaphen), 2-phenylethanol (Phenylethylalkohol), Methyl-3-oxo-2-pentyl-1-cyclopentylacetat (Hedion), 1-(4-isopropylcyclohexyl)-ethanol) (Mugetanol), 3,7-Dimethyloct-6-en-1-ol (Citronellol), (2E)-3,7-Dimethylocta-2,6-dien-1-ol (Geraniol), 2,6-Dimethyl-7-octen-2-ol (Dihydromyrcenol) and/or 2,2-Dimethyl-3-(3-methylphenyl) propan-1-ol (Majantol) and/or Benzyl 2-hydroxybenzoate (Benzyl salicylate).

Preferably, the compound of Formula I is combined with one or more, particularly preferably with two, three, four, five or more of those preferred other fragrances.

Preferably, 5,5-dimethyltetrahydrofuran-2-one is combined with one or more, particularly preferably with two, three, four, five or more of those preferred other fragrances.

Further preferred embodiments listed above also apply to method of the present invention.

Another aspect of the present invention relates to a perfumed product comprising at least one compound of Formula I

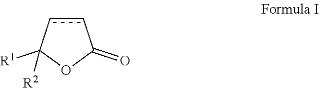

wherein
R¹ represents H, methyl, ethyl, propyl, butyl, hexyl, heptyl, octyl, nonyl, vinyl, allyl, 2-methylprop-1-enyl or 2-methylallyl;
R² represents H, methyl or ethyl and
the dotted line represents a carbon-carbon single bond or a carbon-carbon double bond; and
two or more other fragrances and optionally other ingredients, characterized in that the product comprises the at least one compound of Formula (I) in a quantity which modifies the olfactory properties of the two or more other fragrances to make it rounder, more natural, more volume, more honey, stronger and/or fruitier and/or for imparting, modifying and/or enhancing a fragrance composition to make it less greasy and/or less mushroom.

In a preferred embodiment the perfumed product is selected from cosmetic, hygiene and/or household articles. Further preferred embodiments listed above also apply to the perfumed product of the present invention.

Preferably, the perfumed household article is selected from the group consisting of detergents and cleaning agents, hygiene or care products, preferably in the field of body and hair care, cosmetics and household, preferably from the group consisting of perfume extracts, eau de perfumes, eau de toilets, aftershave lotions, eau de colognes, pre-shave products, splash colognes, perfumed refreshing tissues, acidic, alkaline or neutral cleaning agents, textile fresheners, ironing aids, liquid detergents, powder detergents, laundry pretreatment agents, fabric softeners, Wash tablets, disinfectants, surface disinfectants, air fresheners, aerosol sprays, waxes and polishes, personal care products, hand creams and lotions, foot creams and lotions, depilatory creams and lotions, after shave creams and lotions, tanning creams and lotions, hair care products, hair care products, Products of the decorative cosmetics, candles, lamp oils, incense sticks, insecticides, repellants and fuels. Most preferably, the perfumed product is selected from alcoholic perfume, a personal hygiene product or a cleaning or care product for use in the home.

In addition, it is preferred for the perfumed product according to the invention that at least one compound of Formula I is contained in a sensory effective amount which is sufficient for a consumer to have one or more olfactory properties selected from the group consisting of rounder, more natural, more volume, more honey, stronger and/or fruitier and/or for imparting, modifying and/or enhancing a fragrance composition to make it less greasy and/or less mushroom.

It is also preferred that the total amount the compounds of Formula I, based on the total weight of the perfumed product, is in the range from 0.00001 to 10% by weight, preferably from 0.0001 to 5% by weight %, particularly preferably 0.001 to 2% by weight, more preferably 0.1 to 2% by weight.

The additives, auxiliaries and/or active substances described above are preferably not odoriferous substances. These can be, for example, preservatives, antibacterial agents, chelating agents, cleaning agents, emulsifiers, fats, etc. and in principle all substances that are used as additives, auxiliaries and/or active ingredients in cosmetics, especially in fragrance compositions, as well as in household compositions.

Further preferred embodiments listed above also apply to the perfumed product of the present invention.

In the following, the invention is further characterized on the basis of the examples.

### EXAMPLES

### Example 1: Synthesis of 5,5-dimethyltetrahydrofuran-2-one

### First Manufacturing Example

Under N₂ atmosphere, to a Solution of Methyl-4-oxopentanoate (10.0 g, 76.8 mmol) in 50 ml dry. THF, between m −10 to 0° C. Methyl magnesium bromide (1.4 M in THF, 26.7 mL, 82.8 mmol) was added slowly. After the addition, reaction temperature brought to room temperature and maintained until completion of reaction (˜2 h). To the reaction mixture sat. NH4Cl solution was added, compound extracted using MTBE (50 mL×3) and evaporated in rotatory evaporator (60° C./450-10 mbar) to get the crude (7.2 g). Purification by Kugelrohrdestillation (145° C., 10.0 mbar) gave 6.6 g of title compound.

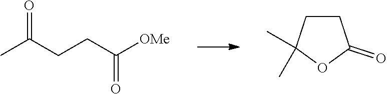

### Second Manufacturing Example

### a) Synthesis of butyl 4-hydroxy-4-methyl-pentanoate

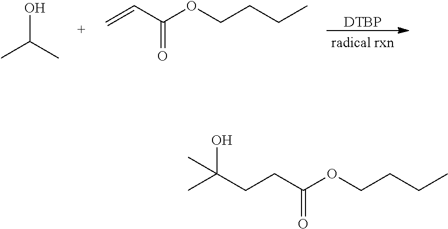

Radical reaction-under nitrogen, a mixture of isopropanol (1950.5 g, 32.5 mol), Butyl acrylate (208.0 g, 1.63 eq) and 2-ter-butylperoxy-2-methyl-propane (22.0 g, 0.2 mol) (DTBP) were heated between 155-160° C. at 10-20 bar for 1 h in a 5 l autoclave. Crude (2212 g) was distilled (Destbrücke) 130-168° C. to get the title compound (23.5 g).

GC-MS: 188, 173, 115, 99, 74, 59, 43, 28

### b) Synthesis of 5,5-dimethyltetrahydrofuran-2-one

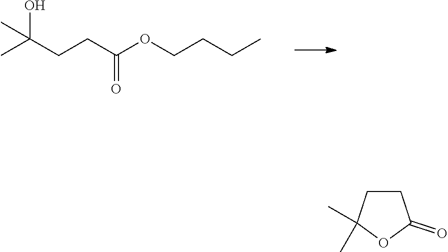

A mixture of butyl 4-hydroxy-4-methyl-pentanoate (23.0 g, ˜100 mmol), methanol (50 mL) and 19 g of NaOH (32%, ˜150 mmol) was refluxed for 2 h. Maximum methanol was evaporated in rotatory evaporator (60° C./350-90 mbar) to get the crude, to this added 10% H2SO4 in water (100 ml) and heated for 40° C. for an hour. At room temperature add NaCl and compound extracted with MTBE (100 ml). Organic layer dried with Na2SO4 and evaporated (50° C., 400-70 mbar), followed by Kugelrohrdestillation (100° C., 15-5 mbar) gave 4.1 g of title compound.

1H NMR (400 MHz, CDCl3) δ 2.62 (t, J=8.2 Hz, 2H), 2.06 (t, J=8.2 Hz, 2H), 1.43 (s, 6H).

13C NMR (101 MHz, CDCl3) δ 176.70, 84.62, 34.70, 29.39, 27.75, 27.75.

MS: 114, 99, 81, 70, 55, 43, 39, 28.

Odor: Fruity, apricot, tonka, cumarin, creamy

### Example 2: Synthesis of 5-ethyl-5-methyl-tetrahydrofuran-2-one

### Synthesis of 4-methylhex-3-enenitrile (Step 1)

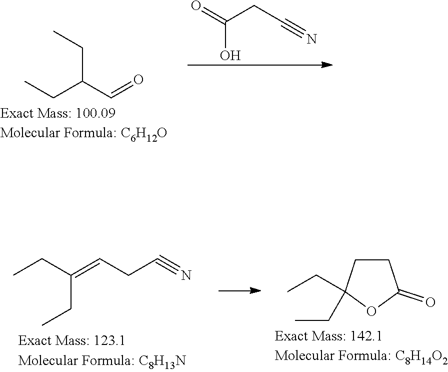

A mixture of Ammonium acetate (2.9 g, 0.04 mol), acetic acid (8.9 g, 0.15 mol), Toluene (250 mL), Methyl-2-butanal (32.0 g, 0.37 mol) and 2-cyanoacetic acid 98% ig (42.0 g, 0.49 mol) were refluxed until complete consumption of aldehyde (˜8 h). Further reaction mixture was maintained between 105-115° C. to eliminate the water for 1 h and decarboxylation for 5 h. After that, reaction mixture was neutralized by washing with 5% H2SO4 (50 ml×2) and evaporated to get roh product (17.2 g). Kugelrohr distillation (60° C., 0.5 mbar) gave 4.6 g of E:Z mixture of nitrile (7:3) of 4-methylhex-3-enenitrile.

1H NMR (400 MHz, C6D6) δ 4.75 (tdt, J=6.9, 2.5, 1.4 Hz, 1H), 2.27-2.21 (m, 2H), 1.67 (qd, J=7.5, 3.9 Hz, 2H), 1.19-1.14 (m, 3H), 0.74 (mc, 3H).

13C NMR (101 MHz, C6D6) δ 143.15, 118.32, 111.31, 31.99, 15.79, 15.75, 12.16.

MS: 109, 94, 82, 67, 56, 41, 27

Odor: herbal, lovage, almond, cinnamon, vegetable

### ii) Synthesis of 5-ethyl-5-methyl-tetrahydrofuran-2-one

A solution of 4-methylhex-3-enenitrile (2.0 g, 18.3 mmol) in toluene (10 mL) was very slowly (30 min) added to a mixture of conc. H2SO4 (2.7 mL) and Water (2.7 mL) at 140° C. and reaction maintained between 117-120° C. until completion of reaction (˜5 h). At room temperature, cold water (10 mL) was added, organic layer washed with water until aq.layer pH is netural and evaporated to get crude product (0.9 g). Kugelrohr distillation (70° C., 0.76 mbar) gave 0.6 g of title compound 5-ethyl-5-methyl-tetrahydrofuran-2-one.

1H NMR (400 MHz, CDCl3) δ 2.70-2.52 (m, 2H), 2.15-2.03 (m, 1H), 1.97 (ddd, J=12.8, 9.5, 6.6 Hz, 1H), 1.80-1.62 (m, 2H), 1.38 (s, 3H), 0.97 (t, J=7.5 Hz, 3H).

13C NMR (101 MHz, CDCl3) δ 176.90, 87.23, 33.61, 32.42, 29.22, 25.17, 8.19.

MS: 128, 113, 99, 84, 73, 86, 43, 27.

Odor: Lactonic, coconut, green

### Example 3: Synthesis of 5,5-diethyltetrahydrofuran-2-one

### Synthesis of 4-ethylhex-3-enenitrile—Step 1

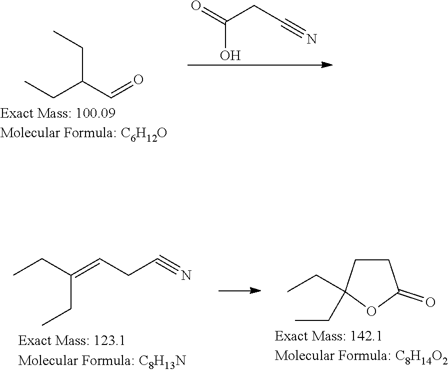

A mixture of Ammonium acetate (1.16 g, 15 mmol), acetic acid (2.17 mL, 38 mmol), Toluene (100 mL), 2-ethylbutanal (10.2 g, 100 mmol) and 2-cyanoacetic acid 98% ig (9.36, 110 mmol) were refluxed, azeotropic distillation until complete consumption of reaction. After that, reaction mixture was neutralized by washing with several timey with water and evaporated to get roh product (7.2 g). Kugelrohr distillation (65° C., 0.5 mbar) gave 4.5 g of E:Z mixture of nitrile (7:3) of 4-ethylhex-3-enenitrile

MS: 123, 108, 96, 81, 67, 55, 41, 27

1H NMR (400 MHz, CDCl3) δ 5.11 (t, J=7.1 Hz, 1H), 3.06 (d, 2H), 2.12-2.00 (m, 4H), 1.05-0.96 (m, 6H).

13C NMR (101 MHz, CDCl3) δ 149.62, 118.89, 109.86, 28.90, 23.54, 15.86, 12.58, 12.25

Odor: mushroom, almond, watery

### ii) Synthesis of 5,5-diethyltetrahydrofuran-2-one-step 2

A solution of 4-ethylhex-3-enenitrile (4.0 g, 32.5 mmol) in toluene (20 mL) was very slowly (30 min) added to a mixture of conc. H2SO4 (5.0 mL) and Water (2.7 mL) at 140° C. Reaction maintained between 128-135° C. until completion of reaction (˜5 h). At room temperature, cold water (10 mL) was added, organic layer washed with water until aq.layer pH is netural and evaporated to get crude product (2.7 g). Kugelrohr distillation (80° C., 0.9 mbar) gave 1.8 g of title compound 5,5-diethyltetrahydrofuran-2-one.

1H NMR (400 MHz, CDCl3) δ 2.65-2.52 (m, 2H), 2.01 (dd, J=9.1, 8.0 Hz, 2H), 1.81-1.57 (m, 4H), 0.94 (t, J=7.5 Hz, 6H).

13C NMR (101 MHz, CDCl3) δ 177.12, 89.63, 30.87, 30.87, 29.82, 29.23, 7.80, 7.80.

MS: 142, 127, 109, 99, 87, 71, 56, 43, 27

Odor: Lactonic, green, fatty, weak coconut

### Example 4: Synthesis of 5-methyl-5-vinyl-tetrahydrofuran-2-one

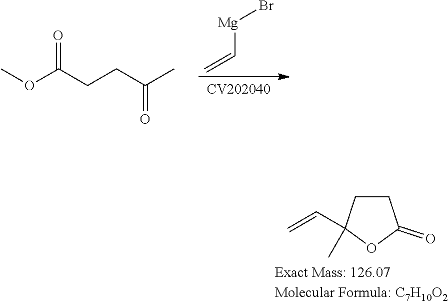

To a Solution of Methyl-4-oxopentanoate (44.5 g, 617.1 mmol) in 50 ml dry. THF, between −10 to 0° C. allyl magnesiumbromide (1.0 M in DEE, 100.0 mL, 99.8 mmol) was added slowly. After the addition reaction temperature brought to room temperature and maintained until completion of reaction (˜3.5 h) at RT. To the reaction mixture sat. NH4Cl solution was added, compound extracted using MTBE (60 ml×3) and evaporated in rotatory evaporator (40° C./450-10 mbar) to get the crude (11.89 g). Purification by Kugelrohrdestillation (90-115° C., 0.1 mbar) gave 6.9 g of title compound.

1H NMR (400 MHz, CDCl3) δ 5.96-5.86 (m, 1H), 5.34-5.26 (m, 1H), 5.19-5.13 (m, 1H), 2.63-2.52 (m, 2H), 2.26-2.17 (m, 1H), 2.14-2.04 (m, 1H), 1.54-1.49 (m, 3H).

13C NMR (101 MHz, CDCl3) δ 176.68, 140.01, 113.73, 85.41, 33.82, 28.74, 26.29

MS: 126, 111, 99, 83, 67, 55, 43, 27.

Odor: Mint, sweet, almond

### Example 5: Synthesis of 5-allyl-5-methyl-tetrahydrofuran-2-one

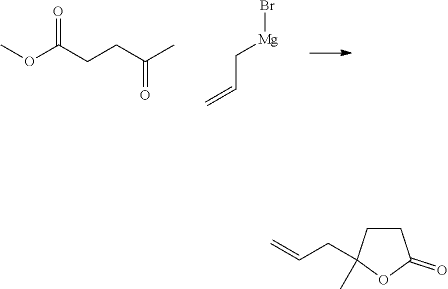

To a Solution of Methyl-4-oxopentanoate (12.0 g, 92.3 mmol) in 50 ml dry. THF, between −10 to 0° C. Vinyl magnesiumchloride (1.0 M in THF, 100.0 g, 99.0 mmol) was added slowly. After the addition reaction temperature brought to room temperature and maintained until completion of reaction (˜2 h) at RT. To the reaction mixture sat. NH4Cl solution was added, compound extracted using MTBE (60 mL×3) and evaporated in rotatory evaporator (40° C./450-10 mbar) to get the crude (10.0 g). Purification by Kugelrohrdestillation (70-130° C., 0.1 mbar), followed by column chromatography (cyclohexane/ethylacetate, 20:1) gave 11.7 g of title compound.

1H NMR (600 MHz, CDCl3) δ 5.79 (ddt, J=16.9, 10.3, 7.3 Hz, 1H), 5.18 (ddt, J=10.3, 2.0, 1.0 Hz, 1H), 5.17 (dq, J=17.0, 1.9, 1.4 Hz, 1H), 2.62 (ddd, J=18.0, 9.5, 7.6 Hz, 1H), 2.57 (ddd, J=18.1, 9.5, 6.7 Hz, 1H), 2.44 (ddt, J=14.0, 7.5, 1.0 Hz, 1H), 2.41 (ddt, J=14.0, 7.4, 1.0 Hz, 1H), 2.16 (ddd, J=12.9, 9.5, 7.6 Hz, 1H), 1.96 (ddd, J=13.0, 9.6, 6.8 Hz, 1H), 1.40 (s, 3H).

13C NMR (151 MHz, CDCl3) δ 176.69, 132.05, 119.78, 85.96, 45.25, 32.15, 29.15, 26.12.

MS. 140, 125, 107, 99, 71, 55, 43, 39, 27

Odor: Fresh, coconut, soft, natural

### Example 6: Synthesis of 5-methyl-5-(2-methylprop-1-enyl)tetrahydrofuran-2-one, 5-methyl-5-(2-methylallyl)tetrahydrofuran-2-one

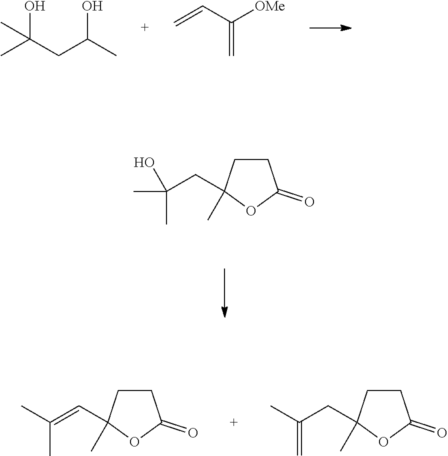

### Synthesis of 5-(2-hydroxy-2-methyl-propyl)-5-methyl-tetrahydrofuran-2-one

A mixture of 2-methyl-2,4-pentandiol (472.7 g, 4.0 mol) and catalytic amount of Aluminiumisopropylate (250 g) were heated to 155° C. To this, a pre-prepared mixture of methylacrylate (43.04 g, 0.50 mol), 2-methyl-2,4-pentandiol (118.18 g, 1.0 mol) and DTBP (7.32 g, 0.05 mol) was added very slowly for about 3 h between 150-155° C. After the addition, first alcohol was distilled followed by product (23.4 g) (R_{T}=110-150° C., H_{T}=46-96° C. at 0.1 mbar) proceed to further step.

### Synthesis of 5-methyl-5-(2-methylprop-1-enyl)tetrahydrofuran-2-one, 5-methyl-5-(2-methylallyl)tetrahydrofuran-2-one

A mixture 5-(2-hydroxy-2-methyl-propyl)-5-methyl-tetrahydrofuran-2-one (23.4 g) and a catalytic amount of K-10 (2.3 g) was distilled using vigreux column (R_{T}=152° C., H_{T}=148-150° C. at 0.1 mbar) gave 17.6 g of product (1:3) of 5-methyl-5-(2-methylprop-1-enyl)tetrahydrofuran-2-one, 5-methyl-5-(2-methylallyl)tetrahydrofuran-2-one

¹H NMR (600 MHz, CDCl₃) δ 5.39 (m_{c}, 1H), 4.95 (dd. J=1.5, 2.2 Hz, 1H), 4.79 (dd. J=0.9, 2.2 Hz, 1H), 2.58 (m_{c}, 4H), 2.42 (dd. J=13.9, 0.9 Hz, 1H), 2.37 (dd. J=0.9, 13.9 Hz, 1H), 2.19 (m_{c}, 3H), 1.94 (ddd. J=6.3, 9.4, 12.9 Hz, 1H), 1.81 (dd. J=1.5, 0.9 Hz, 3H), 1.77 (d, J=1.7 Hz, 3H), 1.73 (d, J=1.7 Hz, 3H), 1.56 (s, 3H), 1.39 (s, 3H).

¹³C NMR (151 MHz, CDCl₃) δ 176.84, 176.72, 140.95, 136.21, 127.61, 116.09, 86.42, 86.06, 48.67, 36.11, 32.97, 29.18, 29.14, 27.29, 26.82, 26.09, 24.06, 19.11.

Odor: tonka, coconut, tobacco

### Example 7: Synthesis of 5-methyl-5-octyl-tetrahydrofuran-2-one

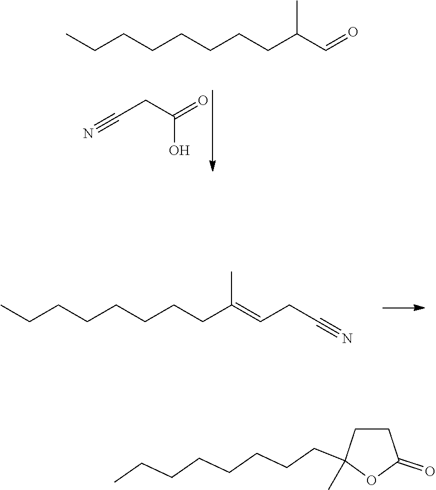

### Synthesis of 4-methyldodec-3-enenitrile

A mixture of Ammonium acetate (2,3 g, 0.03 mol), acetic acid (6.9 g, 6.6 mL, 0.11 mol), Toluene (150 mL), 2-methyl decanal (75.0 g, 0.38 mol) and 2-cyanoacetic acid 98% ig (32.50 g, 0.38 mol) were refluxed for until complete consumption of aldehyde (˜8 h). Further reaction mixture was maintained between 113-118° C. to eliminate the water for 1 h and decarboxylation for 5 h. After that, reaction mixture was neutralized by washing with 5% H₂SO₄ (100 ml×2) and evaporated to get roh product (71.6 g). Kugelrohr distillation (121° C., 0.7 mbar) gave 51 g of E:Z mixture of nitrile (7:3) of 4-methyldodec-3-enenitrile

¹H NMR (400 MHz, CDCl₃) δ 5.15 (tp, J=6.9, 1.4 Hz, 2H), 3.04 (dq, J=7.0, 1.0 Hz, 4H), 2.06-1.98 (m, 4H), 1.74 (q, J=1.3 Hz, 3H), 1.66 (d, J=1.4 Hz, 3H), 1.45-1.31 (m, 4H), 1.31-1.20 (m, 20H), 0.88 (t, J=6.8 Hz, 6H).

¹³C NMR (101 MHz, CDCl₃) δ 142.84, 142.74, 118.71, 118.67, 111.91, 111.28, 39.23, 31.93, 31.88, 31.89, 31.87, 29.53, 29.48, 29.44, 29.25, 29.21, 27.51, 27.51, 23.16, 22.67, 22.66, 16.27, 16.20, 16.09, 14.10, 14.10.

MS: 193, 178, 164, 150, 136, 122, 109, 96, 81, 70, 56, 41, 29

Odor: coriander

### Synthesis of 5-methyl-5-octyl-tetrahydrofuran-2-one

A solution of 4-methyldodec-3-enenitrile (20.0 g, 0.1 mol) in toluene (20 mL) was very slowly (30 min) added to a mixture of conc. H₂SO₄ (8.2 mL) and Water (4.1 mL) at 140° C. Reaction maintained between 130-135° C. until completion of reaction (˜5 h). At room temperature, cold water (10 mL) was added, organic layer washed with water until aq.layer pH is netural and evaporated to get crude product (19.8 g). Kugelrohr distillation (130° C., 0.9 mbar) gave 17.2 g of title compound 5-methyl-5-octyl-tetrahydrofuran-2-one

¹H NMR (400 MHz, CDCl₃) δ 2.68-2.51 (m, 2H), 2.13-2.04 (m, 1H), 2.02-1.92 (m, 1H), 1.73-1.58 (m, 2H), 1.38 (s, 3H), 1.38-1.17 (m, 12H), 0.88 (t, 3H).

¹³C NMR (101 MHz, CDCl₃) δ 176.89, 86.99, 41.02, 32.95, 31.84, 29.85, 29.46, 29.21, 29.21, 25.66, 23.86, 22.65, 14.10.

GC/MS (EI): 212, 197, 179, 114, 99, 83, 71, 55, 43

Odor: weak lactonic and fatty

### Example 8: Synthesis of 5-methyl-5-nonyl-tetrahydrofuran-2-one

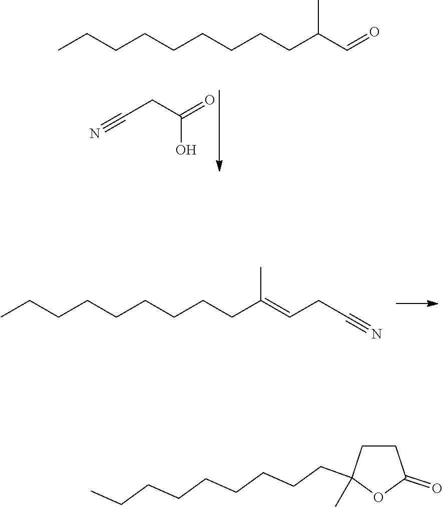 [SMILES: CCCCCCCCCC(C)C=O ; N#CCC(=O)O ; CCCCCCCCC/C(C)=C/CC#N ; CCCCCCCCCC1(C)CCC(=O)O1]

### Synthesis of (E/Z) 4-methyltridec-3-enenitrile

A mixture of Ammonium acetate (2,3 g, 0.03 mol), acetic acid (6.9 g, 6.6 mL, 0.11 mol), Toluene (150 mL), 2-methyl undecanal (70.0 g, 0.38 mol) and 2-cyanoacetic acid 98% ig (32.50 g, 0.38 mol) were refluxed for until complete consumption of aldehyde (˜8 h). Further reaction mixture was maintained between 113-118° C. to eliminate the water for 1 h and decarboxylation for 5 h. After that, reaction mixture was neutralized by washing with 5% H₂SO₄ (100 mL×2) and evaporated to get roh product (61.9 g). Kugelrohr distillation (128° C., 0.7 mbar) gave 42.6 g of E:Z mixture of 4-methyltridec-3-enenitrile (2:1).

¹H NMR (400 MHz, CDCl₃) δ 5.15 (ddq, J=6.9, 5.6, 1.4 Hz, 2H), 3.04 (dq, J=7.0, 0.9 Hz, 4H), 2.02 (dd, J=8.8, 6.7 Hz, 4H), 1.74 (q, J=1.3 Hz, 3H), 1.66 (q, J=1.0 Hz, 3H), 1.48-1.35 (m, 4H), 1.34-1.20 (m, 24H), 0.94-0.83 (m, 6H).

¹³C NMR (101 MHz, CDCl₃) δ 142.84, 142.75, 118.71, 118.61, 111.91, 111.28, 39.24, 31.94, 31.90, 31.88, 29.55, 29.53, 29.48, 29.36, 29.32, 29.31, 29.21, 27.52, 23.16, 22.68, 22.68, 16.27, 16.20, 16.09, 14.11, 14.11.

MS: 207, 192, 178, 164, 150, 136, 112, 96, 83, 70, 55, 43, 29.

Odor: orange, nitrile, fatty

### Synthesis of 5-methyl-5-nonyl-tetrahydrofuran-2-one

A solution of 4-methyltridec-3-enenitrile (20.0 g, 0.1 mol) in toluene (20 mL) was very slowly (30 min) added to a mixture of conc. H₂SO₄ (8.2 mL) and Water (4.1 mL) at 140° C. Reaction maintained between 130-135° C. until completion of reaction (˜5 h). At room temperature, cold water (10 mL) was added, organic layer washed with water until aq.layer pH is netural and evaporated to get crude product (19.3 g). Kugelrohr distillation (130° C., 0.9 mbar) gave 17.6 g of title compound 5-methyl-5-nonyl-tetrahydrofuran-2-one

¹H NMR (400 MHz, CDCl3) δ 2.69-2.50 (m, 2H), 2.09 (ddd, J=12.9, 9.3, 8.0 Hz, 1H), 1.97 (ddd, J=12.8, 9.4, 6.6 Hz, 1H), 1.70-1.57 (m, 2H), 1.38 (s, 3H), 1.36-1.19 (m, 14H), 0.94-0.82 (m, 3H).

¹³C NMR (101 MHz, CDCl3) δ 176.88, 86.98, 41.02, 32.95, 31.87, 29.85, 29.53, 29.51, 29.29, 29.21, 25.66, 23.86, 22.68, 14.11.

MS: 226, 211, 193, 171, 151, 127, 114, 99, 83, 71, 55, 43, 29.

Odor: too weak lactonic

### Example 9: Synthesis of 5-butyl-5-ethyl-tetrahydrofuran-2-one

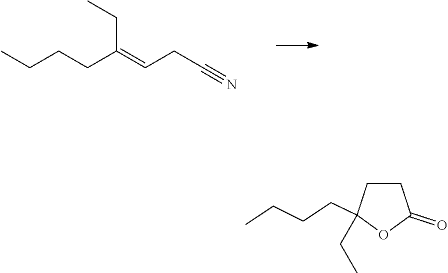

### Synthesis of (E/Z)-4-ethyloct-3-enenitrile: prepared according to WO 2018192665

¹H NMR (400 MHz, CDCl₃) δ 5.17-5.08 (m, 2H), 3.07 (s, 4H), 2.13-1.97 (m, 8H), 1.35 (s, 8H), 1.01 (t, J=7.4 Hz, 3H), 1.00 (t, J=7.6 Hz, 3H), 0.92 (t, J=7.1 Hz, 3H), 0.91 (t, J=7.2 Hz, 3H).

¹³C NMR (101 MHz, CDCl₃) δ 148.29, 148.21, 118.87, 118.85, 110.81, 110.41, 35.87, 30.27, 30.13, 29.89, 29.31, 23.35, 22.77, 22.41, 16.05, 15.88, 13.94, 13.94, 12.56, 12.30.

Odor: rose, green, nitrile, iris, carrot, dry

### Synthesis of 5-butyl-5-ethyl-tetrahydrofuran-2-one

A solution of con. H₂SO₄ (75.0 g) in water (25.5 g) was heated to 140° C. To this very slowly added 4-ethyl-oct-3-ennitrile (Lit: Symrise AG; WO2018192665) (100.0 g, 0.66 mol) for about 1 h (very strong exothermic) and reaction maintained for 2 h 130-135° C. At room temperature reaction mixture was poured into cold water, neutralized, evaporated to get crude (99.8 g). Purification by spaltrohr followed by kugelrohr distillation gave 77.6 g of product.

MS: 141, 113, 95, 81, 69, 57, 41

¹H NMR (400 MHz, CDCl₃) δ 2.58 (dd, J=9.1, 8.0 Hz, 2H), 2.02 (dd, J=9.1, 8.0 Hz, 2H), 1.77-1.66 (m, 2H), 1.68-1.60 (m, 2H), 1.41-1.24 (m, 4H), 0.94 (t, J=7.4 Hz, 3H), 0.91 (t, 3H).

¹³C NMR (101 MHz, CDCl₃) δ 171.10, 89.41, 38.00, 31.34, 30.33, 29.22, 25.57, 22.99, 13.97, 7.86.

Odor: coconut, lactone, fruity

### Example 10: Synthesis of 5-butyl-5-ethyl-furan-2-one

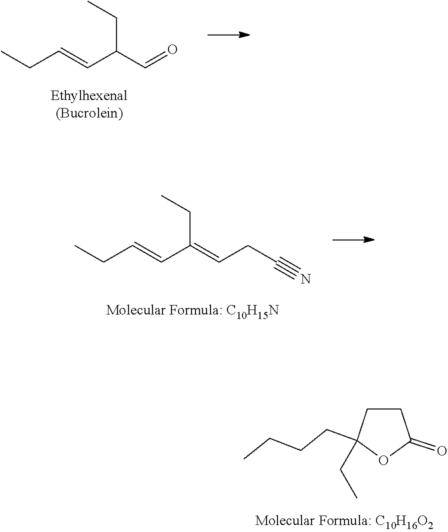

### Synthesis of 4-ethylocta-3,5-dienenitrile

A mixture of Ammonium acetate (4.7 g, 0.06 mol), acetic acid (13.8 g, 0.23 mol), Toluene (300 g), 2-Ethylhex-2-enal (100.0 g, 0.75 mol) and 2-cyanoacetic acid 98% ig (64.50 g, 0.76 mol) were refluxed for until complete consumption of aldehyde (˜8 h). Further reaction mixture was maintained between 113-118° C. to eliminate the water for 1 h and decarboxylation for 5 h. After that, reaction mixture was neutralized by washing with 5% H₂SO₄ (100 mL×2) and evaporated to get roh product (113.8 g). Kugelrohr distillation (60-90° C., 0.5 mbar) gave 59 g of E:Z mixture of nitrile (7:3) of title compound.

¹H NMR (400 MHz, CDCl₃) δ 5.92 (d, J=15.9 Hz, 1H), 5.85-5.79 (m, 1H), 5.26 (t, J=7.2 Hz, 1H), 3.15 (d, J=7.2 Hz, 2H), 2.31-2.17 (m, 2H), 2.17-2.07 (m, 2H), 1.13-0.98 (m, 6H).

¹³C NMR (101 MHz, CDCl₃) δ 145.40, 132.73, 130.07, 118.29, 114.53, 25.87, 20.21, 16.11, 13.61, 13.28.

MS: 149, 134, 120, 10

Odor: green, cucumber, soapy, nitrile

### Synthesis of 5-butyl-5-ethyl-furan-2-one

A solution of con. H₂SO₄ (7.5 g) in water (2.6 g) was heated to 140° C. To this very slowly added 4-ethyl-octa-3,5-dienenitrile (7.5 g, 0.07 mol) for about 30 min (very strong exothermic) and reaction maintained for 2 h 130-135° C. At room temperature reaction mixture was poured into cold water, neutralized, evaporated to get crude (1.7 g). Purification by kugelrohr distillation (105° C., 0.8 mbar) gave 0.6 g of product.

MS: 168, 139, 113, 95, 67, 57, 41, 29

GC-Sniff: pungent, technical, dusty

### Example 11: Odor Description of Preferred Fragrances after Addition of 4-cyclohexylbutan-2-one

The odor evaluation and description has been performed by an expert panel.

TABLE 2
Odor description of different fragrance mixtures after the addition of

| | Molecular | | | Amount of | |
|---|---|---|---|---|---|
| Nr.: | weight | Name | Structure | Lactones in Table 1 | Geruch |
| 1 | 178 | Rosaphen | 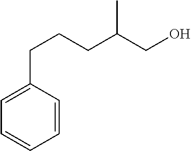 | 0.2% | rounder, less greasy, more natural more volume |
| 2 | 122 | Phenylethylalkohol | 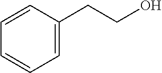 | 0.2% | less greasy, more natural with a note of honey |
| 3 | 226 | Hedion | 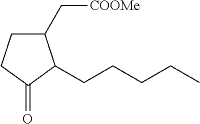 [SMILES: CCCCCC1C(=O)CCC1CC(=O)OC] | 0.2% | fuller, less mushroom, with a tuberose effect |
| 4 | 170 | Mugetanol | 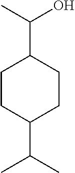 | 0.2% | stronger, more volume |
| 5 | 156 | Citronellol | 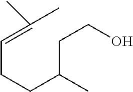 | 0.2% | rounder, stronger, more natural with a note of pineapple |
| 6 | 154 | Geraniol | 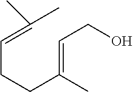 | 0.2% | stronger, more volume, more natural |
| 7 | 228 | Benzylsalicylat | 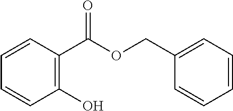 [SMILES: O=C(OCc1ccccc1)c1ccccc1O] | 0.2% | stronger, with a note of coconut |

1. Use of at least one compound of Formula I 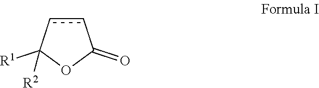
as a fragrance,
wherein
R¹ represents H, methyl, ethyl, propyl, butyl, hexyl, heptyl, octyl, nonyl, vinyl, allyl, 2-methylprop-1-enyl or 2-methylallyl;
R² represents H, methyl or ethyl; and
the dotted line represents a carbon-carbon single bond or a carbon-carbon double bond.

2. Use according to claim 1, wherein R¹ represents methyl, ethyl, butyl, vinyl, allyl, 2-methylprop-1-enyl, 2-methylallyl, octyl or nonyl; and R² represent methyl or ethyl.

3. Use according to claim 1 and/or 2, wherein the compound of Formula I is selected from the group consisting of 5,5-dimethyltetrahydrofuran-2-one, 5-ethyl-5-methyl-tetrahydrofuran-2-one, 5,5-diethyltetrahydrofuran-2-one, 5-methyl-5-vinyl-tetrahydrofuran-2-one, 5-allyl-5-methyl-tetrahydrofuran-2-one, 5-methyl-5-(2-methylprop-1-enyl)tetrahydrofuran-2-one, 5-methyl-5-(2-methylallyl)tetrahydrofuran-2-one, 5-methyl-5-octyl-tetrahydrofuran-2-one, 5-methyl-5-nonyl-tetrahydrofuran-2-one, 5-butyl-5-ethyl-tetrahydrofuran-2-one, 5-butyl-5-ethyl-furan-2-one.

4. Use according to claim 1 and/or 2, wherein the compound of Formula I is 5,5-dimethyltetrahydrofuran-2-one.

5. Use according to claims 1 to 4 in fragrance compositions to obtain at least one of the following fragrance notes: fruity, apricot, cumarin, creamy, coconut, green, mint, sweet, almond, fresh, soft, natural, tonka, tobacco, hay.

6. Use according to claims 1 to 5 for imparting, modifying and/or enhancing a fragrance composition to make it rounder, more natural, more volume, more honey, stronger and/or fruitier and/or for imparting, modifying and/or enhancing a fragrance composition to make it less greasy and/or less mushroom.

7. Fragrance composition comprising or consisting of at least one compound of Formula I 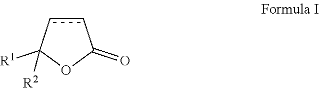
wherein
R¹ represents H, methyl, ethyl, propyl, butyl, hexyl, heptyl, octyl, nonyl, vinyl, allyl, 2-methylprop-1-enyl or 2-methylallyl;
R² represents H, methyl or ethyl; and
the dotted line represents a carbon-carbon single bond or a carbon-carbon double bond; and
at least one further fragrance.

8. Fragrance composition according to claim 8, wherein the compound of Formula I is selected from the group consisting of 5,5-dimethyltetrahydrofuran-2-one, 5-ethyl-5-methyl-tetrahydrofuran-2-one, 5,5-diethyltetrahydrofuran-2-one, 5-methyl-5-vinyl-tetrahydrofuran-2-one, 5-allyl-5-methyl-tetrahydrofuran-2-one, 5-methyl-5-(2-methylprop-1-enyl)tetrahydrofuran-2-one, 5-methyl-5-(2-methylallyl)tetrahydrofuran-2-one, 5-methyl-5-octyl-tetrahydrofuran-2-one, 5-methyl-5-nonyl-tetrahydrofuran-2-one, 5-butyl-5-ethyl-tetrahydrofuran-2-one, 5-butyl-5-ethyl-furan-2-one.

9. Fragrance composition according to claim 7 and/or 8, wherein the weight ratio of the at least one compound of Formula I to the total amount of other fragrances is in the range of 1:10 to 1:100.

10. Fragrance composition according to claim 9, wherein the weight ratio of the at least one compound of Formula I to the total amount of other fragrances is in the range of 1:600 to 1:400.

11. Fragrance composition according to claims 7 to 10, wherein the amount of the at least one compound of Formula I is in the range of 0.01 to 5% by weight, based on the total weight of the fragrance composition.

12. Fragrance composition according to at least one of claims 7 to 11, the at least one compound of Formula I is contained in the fragrance composition in a sensory effective amount sufficient to modify an existing fragrance to make it rounder, more natural, more volume, more honey, stronger and/or fruitier and/or for imparting, modifying and/or enhancing a fragrance composition to make it less greasy and/or less mushroom.

13. Fragrance composition according to at least one of claims 7 to 12, wherein the at least one further fragrance is selected from the group consisting of 4-cyclohexylbutan-2-ol (Cyclohexylmagnol), 2-methyl-5-phenylpentan-1-ol (Rosaphen), 2-phenylethanol (Phenylethylalkohol), Methyl-3-oxo-2-pentyl-1-cyclopentylacetat (Hedion), 1-(4-isopropylcyclohexyl)-ethanol) (Mugetanol), 3,7-Dimethyloct-6-en-1-ol (Citronellol), (2E)-3,7-Dimethylocta-2,6-dien-1-ol (Geraniol), 2,6-Dimethyl-7-octen-2-ol (Dihydromyrcenol) and/or 2,2-Dimethyl-3-(3-methylphenyl) propan-1-ol (Majantol), Benzyl 2-hydroxybenzoate (Benzyl salicylate).

14. Use of a fragrance composition according to any one of claims 7 to 13 to modify an existing fragrance to make it rounder, more natural, more volume, more honey, stronger and/or fruitier and/or for imparting, modifying and/or enhancing a fragrance composition to make it less greasy and/or less mushroom.

15. Perfumed product comprising at least one compound of Formula I 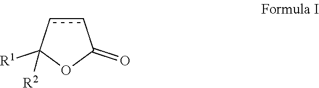
wherein
R¹ represents H, methyl, ethyl, propyl, butyl, hexyl, heptyl, octyl, nonyl, vinyl, allyl, 2-methylprop-1-enyl or 2-methylallyl;
R² represents H, methyl or ethyl; and
the dotted line represents a carbon-carbon single bond or a carbon-carbon double bond; and
two or more other fragrances and optionally other ingredients, characterized in that the product comprises the at least one compound of Formula (I) in a quantity which modifies the olfactory properties of the two or more other fragrances to make it rounder, more natural, more volume, more honey, stronger and/or fruitier and/or for imparting, modifying and/or enhancing a fragrance composition to make it less greasy and/or less mushroom.
